(19) United States
(12) Patent Application Publication
(10) Pub. No.: US 2023/0026077 A1
(43) Pub. Date: Jan. 26, 2023

(54) STOW BAR FOR AIRCRAFT FUEL NOZZLE, AIRCRAFT FUEL NOZZLE HAVING STOW BAR, AND METHOD OF ATTACHING STOW BAR TO AIRCRAFT FUEL NOZZLE

(71) Applicant: William D. Johnson, III, Baytown, TX (US)

(72) Inventor: William D. Johnson, III, Baytown, TX (US)

(21) Appl. No.: 17/862,922

(22) Filed: Jul. 12, 2022

Related U.S. Application Data
(60) Provisional application No. 63/221,298, filed on Jul. 13, 2021.

(51) Int. Cl. B67D 7/42; B64F 1/28

(52) U.S. Cl. CPC B67D 7/42; B64F 1/28

(57) ABSTRACT

A stow bar for an aircraft fuel nozzle includes a U-shaped body formed of a base part, a first arm extending from one side of the base part, and a second arm extending from an opposite side of the base part. Each of the first arm and the second arm includes a free end located distally of the base part. Each free end includes a male connector for insertion through an aperture in a housing or a flange of the aircraft fuel nozzle. The stow bar is formed of a single, solitary piece of material. The single, solitary formation of the male connectors with the stow bar provide increased strength and durability to the stow bar connection with the fuel nozzle, and is an improvement over known support bar designs having female threaded connectors which receive screws that are prone to break and leave debris within the female connectors.

### CROSS REFERNCE TO RELATED APPLICATIONS

This application is a non-provisional application that claims priority to U.S. Provisional Application No. 63/221,298, filed on Jul. 13, 2021. The disclosure of the prior application is hereby incorporated by reference herein in its entirety.

### TECHNICAL FIELD

The present disclosure relates to a stow bar that attaches to an aircraft fuel nozzle. In particular, the disclosure relates to a stow bar having a configuration which provides increased strength and durability to the stow bar and its connection with the aircraft fuel nozzle.

### BACKGROUND

Aircraft fueling systems often include a fuel nozzle provided at the end of a fuel line. Some fuel nozzles include a support bar or a guard bar attached to the fuel nozzle which may function as a handle that may be gripped by a person, or as protector of the fuel nozzle (or components thereon) against impact from other objects. Known support bars and guard bars are formed with female threaded connectors at ends of the bars for attaching the bars to a fuel nozzle via screws. For instance, the female threaded connectors are positioned adjacent screw holes in the fuel nozzle, and a screw is inserted through each hole and into one of the female threaded connectors. A problem with such a design is that the screws are prone to break, which results in unwanted detachment of the bars with the fuel nozzle. Moreover, the broken screws leave debris within the female threaded connectors. The debris is difficult to remove, making repairs time consuming and costly.

### SUMMARY

A need exists for a stow bar having a configuration that provides increased strength and durability to the stow bar and its connection with the aircraft fuel nozzle. The present disclosure meets these needs.

The present disclosure discusses a stow bar having a configuration that provides increased strength and durability to the stow bar and its connection with an aircraft fuel nozzle. The stow bar may be a one-piece U-shaped steel bar. The end of each arm of the U-shaped bar may have external threads, and may be sized to extend through an aperture in the housing or in a flange of the aircraft fuel nozzle. The end of each arm is thus a male threaded connector formed integrally in one single, solitary piece with the stow bar. The threads of the male threaded connector may be configured to receive a nut to secure the stow bar to the aircraft fuel nozzle after the male threaded connectors are inserted through the apertures in the fuel nozzle. The single, solitary formation of the male threaded connectors with the stow bar provide increased strength and durability to the stow bar and its connection with the fuel nozzle, and is an improvement over known support bar designs having female threaded connectors which receive screws that are prone to break and leave debris within the female connectors. A portion of each arm having the male threaded connector may be angled upward relative to the remainder of the stow bar in order to provide the stow bar, when connected to the aircraft fuel nozzle, with a shape that interacts with a limit switch of a refueling vehicle when the fuel nozzle is stowed on the vehicle.

In one embodiment, a stow bar for an aircraft fuel nozzle comprises a U-shaped body formed of a base part, a first arm extending from one side of the base part, and a second arm extending from an opposite side of the base part, wherein each of the first arm and the second arm comprises a free end located distally of the base part, and the free end comprises a male connector for insertion through an aperture in a housing or a flange of the aircraft fuel nozzle.

In an embodiment, the male connector comprises threads.

In an embodiment, the stow bar is a single, solitary piece.

In an embodiment, a material of the stow bar is steel.

In an embodiment, the stow bar further comprises a threaded nut for engaging with the male connector.

In an embodiment, the free end of each of the first arm and the second arm extends at an angle relative to the base part.

In an embodiment, a diameter of the male connector is less than a diameter of the first arm and the second arm.

In a further embodiment, an aircraft fuel nozzle comprises a nozzle part for dispensing fuel; a housing comprising a first aperture and a second aperture; and a stow bar comprising a U-shaped body formed of a base part, a first arm extending from one side of the base part, and a second arm extending from an opposite side of the base part, wherein each of the first arm and the second arm comprises a free end located distally of the base part and extending through one of the first aperture and the second aperture, and the free end comprises a male connector.

In an embodiment,

In an embodiment, the male connector comprises threads, and the stow bar further comprises a nut attached to the male connector for securing the stow bar to the housing.

In an embodiment, the stow bar is a single, solitary piece.

In an embodiment, the free end of each of the first arm and the second arm extends at an angle relative to the base part.

In an embodiment, the stow bar is configured to interact with a limit switch of a refueling vehicle when the aircraft fuel nozzle is stowed on the refueling vehicle.

In an embodiment, a refueling vehicle comprises the aircraft fuel nozzle and a limit switch for controlling a power supply to the refueling vehicle, wherein the stow bar is configured to interact with the limit switch when the aircraft fuel nozzle is stowed on the refueling vehicle.

In another embodiment, a method of attaching a U-shaped stow bar to an aircraft fuel nozzle comprises inserting a free end of a first arm and a free end of a second arm of the U-shaped stow bar through a first aperture and a second aperture, respectively, of a housing of the aircraft fuel nozzle, wherein the free end comprises a male connector; attaching a first nut to the male connector of the first arm; and attaching a second nut to the male connector of the second arm.

In an embodiment, the free end of each of the first arm and the second arm extends at an angle relative to a base part of the U-shaped stow bar so that the base part is disposed at an angle relative to the aircraft fuel nozzle when the free end of the first arm and the free end of the second arm are inserted through the first aperture and the second aperture, respectively, of the housing.

In an embodiment, the stow bar is a single, solitary piece.

In an embodiment, the male connector comprises threads.

### BRIEF DESCRIPTION OF THE FIGURES

Various embodiments are hereafter described in detail and with reference to the drawings wherein like reference characters designate like or similar elements throughout the several figures and views that collectively comprise the drawings.

FIG. 1 is a perspective view of a stow bar for an aircraft fuel nozzle, according to an embodiment.

FIG. 2 is a top plan view of the stow bar shown in FIG. 1, according to an embodiment.

FIG. 3 is a side view of the stow bar shown in FIG. 1, according to an embodiment.

FIG. 4 is a perspective view of an aircraft fuel nozzle, according to an embodiment.

FIG. 5 is a close-up view of the aircraft fuel nozzle, according to an embodiment.

FIG. 6 is a perspective view of the stow bar attached to the aircraft fuel nozzle, according to an embodiment.

FIG. 7 is a top view of the stow bar attached to the aircraft fuel nozzle, according to an embodiment.

FIG. 8 is a close-up view of a nut securing the stow bar to the aircraft fuel nozzle, according to an embodiment.

FIG. 9 is another view of the nut securing the stow bar to the aircraft fuel nozzle, according to an embodiment.

FIG. 10 is a perspective view of the aircraft fuel nozzle and attached stow bar interacting with a limit switch of a refueling vehicle when the fuel nozzle is stowed on the vehicle.

FIG. 11 is a close-up view of the stow bar interacting with the limit switch of the refueling vehicle.

### DETAILED DESCRIPTION

Before describing selected embodiments of the present disclosure in detail, it is to be understood that the present invention is not limited to the particular embodiments described herein. The disclosure and description herein is illustrative and explanatory of one or more presently preferred embodiments and variations thereof, and it will be appreciated by those skilled in the art that various changes in the design, organization, means of operation, structures and location, methodology, and use of mechanical equivalents may be made without departing from the spirit of the invention.

It should also be understood that the drawings are intended to illustrate and plainly disclose presently preferred embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

Moreover, it will be understood that various directions such as “upper”, “lower”, “bottom”, “top”, “left”, “right”, and so forth are made only with respect to explanation in conjunction with the drawings, and that components may be oriented differently, for instance, during transportation and manufacturing as well as operation. Because many varying and different embodiments may be made within the scope of the concept(s) herein taught, and because many modifications may be made in the embodiments described herein, it is to be understood that the details herein are to be interpreted as illustrative and non-limiting.

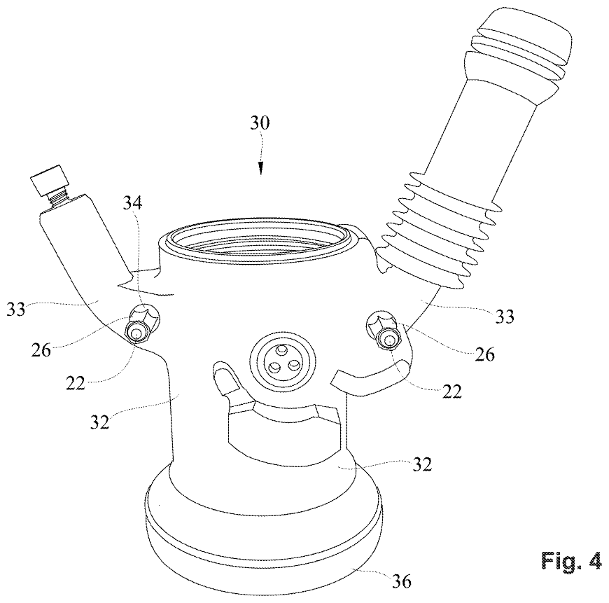

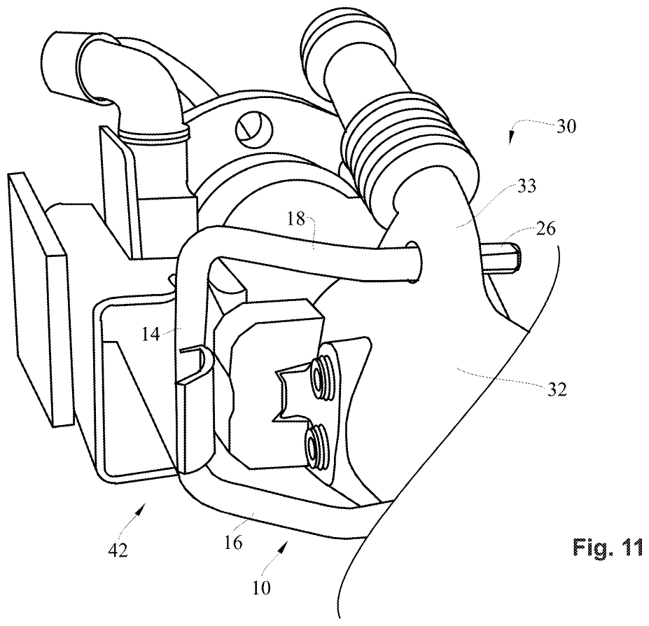

FIG. 1 illustrates a perspective view of a stow bar 10 for an aircraft fuel nozzle 30 (see FIGS. 4 to 9), according to an embodiment. The stow bar 10 may have a U-shaped body 12 or a substantially U-shaped body 14. The actual “U-shape” of the U-shaped body 12 is not particularly limiting, and may form a block-shaped U as shown in FIG. 1. In other embodiments, the “U-shape” of the U-shaped body 12 may be more rounded at the base as in the traditional shape of the letter “U”. In all embodiments, the U-shaped body 12 may be formed of a base part 14, a first arm 16 extending from one side of the base part 14, and a second arm 18 extending from an opposite side of the base part 14, as shown in FIG. 1. The base part 14, the first arm 16, and the second arm 18 may all have the same outer diameter as illustrated. In some embodiments, the outer diameter of the base part 14 may be different (larger or smaller) than outer diameter of the first arm 16 and the second arm 18. In the illustrated embodiment, the outer diameter of the base part 14, the first arm 16, and the second arm 18 is 0.5 inches. However, the size of the outer diameter may be smaller or larger than 0.5 inches. Each of the first arm 16 and the second arm 18 includes a free end 20 located distally of the base part 14, as shown in FIG. 1. In the illustrated embodiment, the free end 20 of each of the first arm 16 and the second arm 18 extends at an angle upward relative to the base part 14. In one example, the angle may be 45 degrees. The angle of the free end 20 of each of the first arm 16 and the second arm 18 is not particularly limiting, and may be greater or less than 45 degrees. The angle of the free end 20 of each of the first arm 16 and the second arm 18 may help the stow bar 10 interact with a limit switch 42 of a refueling vehicle 40 when an aircraft fuel nozzle 30 having the stow bar 10 is stowed on the refueling vehicle 40, as discussed later in detail below with respect to FIGS. 10 and 11.

Further, each free end 20 comprises a male connector 22 for insertion through an aperture 34 in a housing 32 or a flange 33 of the aircraft fuel nozzle 30, as discussed below with respect to FIGS. 4 to 9. In one embodiment, the male connector 22 may comprise threads 24. The threads 24 may be configured to pass through the aperture 34 in the housing 32 or the flange 33 of the aircraft fuel nozzle 30 and engage with a threaded nut 26 on the other side of the aperture 34 for securing the stow bar 10 to the aircraft fuel nozzle 30. The diameter of the male connector 22 may be less than the diameter of each of the first arm 16 and the second arm 18, as shown in FIG. 1. In one embodiment, the diameter of the male connector 22 may be 0.3125 inches. However, the diameter of the male connector 22 is not particularly limiting, and may be greater or less than 0.3125 inches. The length of the male connector 22 in the illustrated embodiment is 1.5 inches. However, the length of the male connector 22 is not particularly limiting, and may be greater or less than 1.5 inches, so long as the length of the male connector 22 is sufficient for the male connector 22 to engage with the nut 26 on the other side of the aperture 34 of the aircraft fuel nozzle 30 for securing the stow bar 10 to the aircraft fuel nozzle 30. In other embodiments, the male connector 22 may comprise attachment means other than threads 24.

The embodiment of FIG. 1 shows that the stow bar 10 is formed integrally as one single, solitary (or unitary) piece of material, rather than separate pieces connected together. The single, solitary (or unitary) construction of the stow bar 10 provides increased strength and durability to the stow bar 10 and its connection with the aircraft fuel nozzle 30, as compared with conventional support bars and guard bars that are formed with female threaded connectors that receive screws for attaching the bars to a fuel nozzle. A problem with such a design is that the screws are prone to break, which results in unwanted detachment of the bars with the fuel nozzle. Moreover, the broken screws leave debris within the female threaded connectors. The debris is difficult to remove, making repairs time consuming and costly. On the other hand, the one-piece construction of the male connectors 22 with the stow bar 10 has an increased strength that is not as prone to break as the screws that are inserted into the conventional female connectors. In one embodiment, the material of the stow bar 10 is stainless steel. In other embodiments, the material may be another type of steel, ceramic, iron, a composite plastic, or a combination of materials.

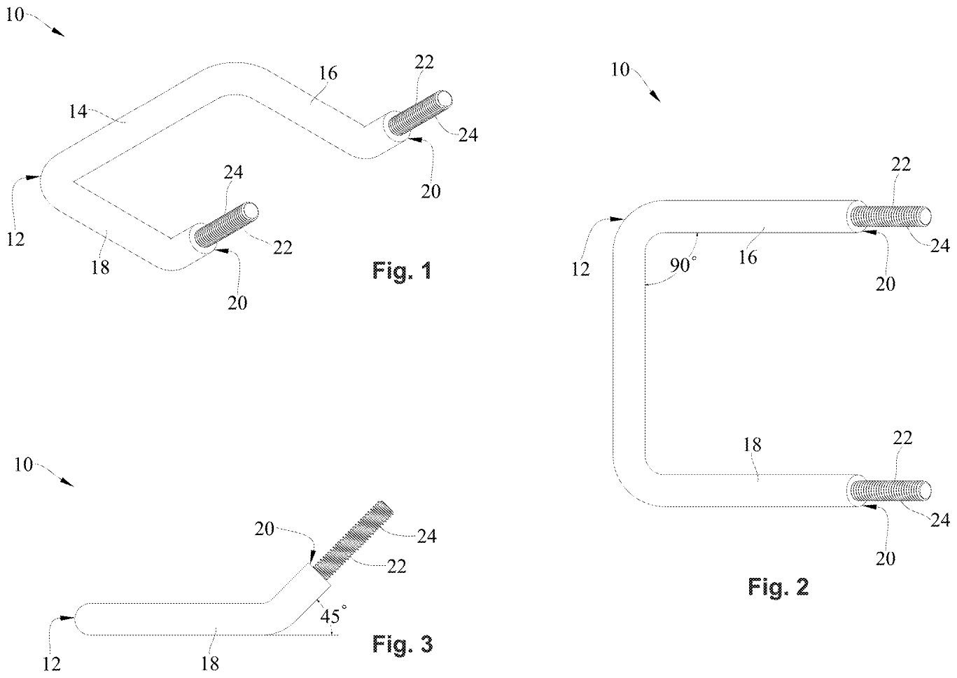

FIG. 2 is a top plan view of the stow bar shown in FIG. 1, according to an embodiment. In the illustrated embodiment, the length of the base part 14 of the stow bar 10 is about 4.29 inches as measured from the centerline of the first arm 16 to the centerline of the second arm 18. However, the length of the base part 14 is not particularly limiting, and may be greater or less than 4.29 inches, so long as the length of base part 14 is sufficient for the male connectors 22 to align with the apertures 34 of the aircraft fuel nozzle 30 for securing the stow bar 10 to the aircraft fuel nozzle 30. FIG. 3 is a side view of the stow bar shown in FIG. 1, according to an embodiment. In the illustrated embodiment, the length of the first arm 16 and the second arm 18 is 2.625 inches as measured from the centerline of the base part 14 to the bend of the free end 20, which may extend upwardly relative to the base part 14 at an angle of 45 degrees, as discussed above. However, the length of the first arm 16 and of the second arm 18 is not particularly limiting, and may be greater or less than 2.625 inches. In the illustrated embodiment, the length of the free end 20 is 1 inch from the bend to the proximal end of the male connector 22. However, the length of the free end 20 is not particularly limiting, and may be greater or less than 1 inch. As discussed above, the length of the male connector 22 is 1.5 inches from the free end 20. However, the length of the male connector 22 is not particularly limiting, and may be greater or less than 1.5 inches, so long as the length is sufficient for the male connector 22 to engage with the nut 26 on the other side of the aperture 34 of the aircraft fuel nozzle 30 for securing the stow bar 10 to the aircraft fuel nozzle 30.

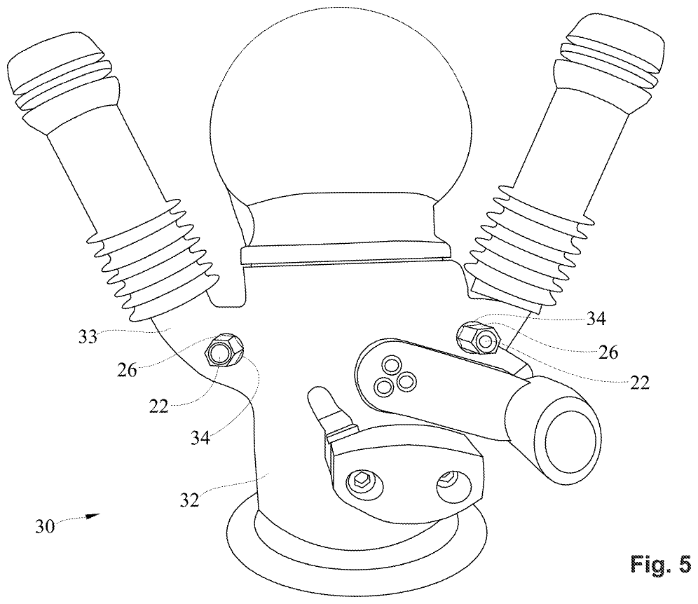

FIG. 4 is a perspective view of an aircraft fuel nozzle 30 for refueling an aircraft, according to an embodiment. The aircraft fuel nozzle 30 may include a nozzle part 36 for dispensing fuel, such as jet fuel. The aircraft fuel nozzle 30 may also include a housing 32 comprising first and second apertures 34 on opposite sides of the housing 32. In some embodiments, the each aperture 34 may be provided on a flange 33 of the housing 32. Also shown in FIG. 4 are the male connectors 22 inserted through the apertures 34, and a nut 26 attached to each male connector 22 for securing the stow bar 10 to the aircraft fuel nozzle 30. FIG. 5 is a close-up view of the aircraft fuel nozzle 30, according to an embodiment, and shows that each nut 26 may be an extended nut. An extended nut has a length that is greater than the height of the nut. An extended nut may be beneficial because it may have additional threads for engagement with the threads 24 of the male connector 22 for added security/tightness. In some embodiments, an adhesive type material or securing agent may be provided between the threads 24 of the male connector 22 and the threads of the nut 26.

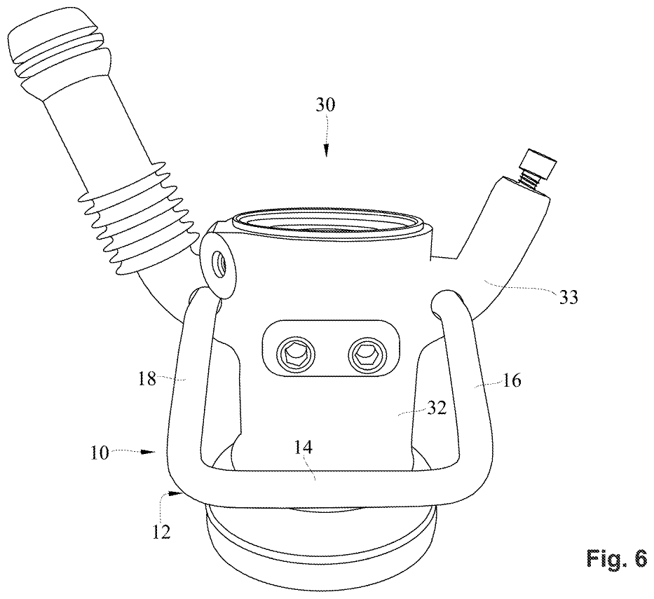

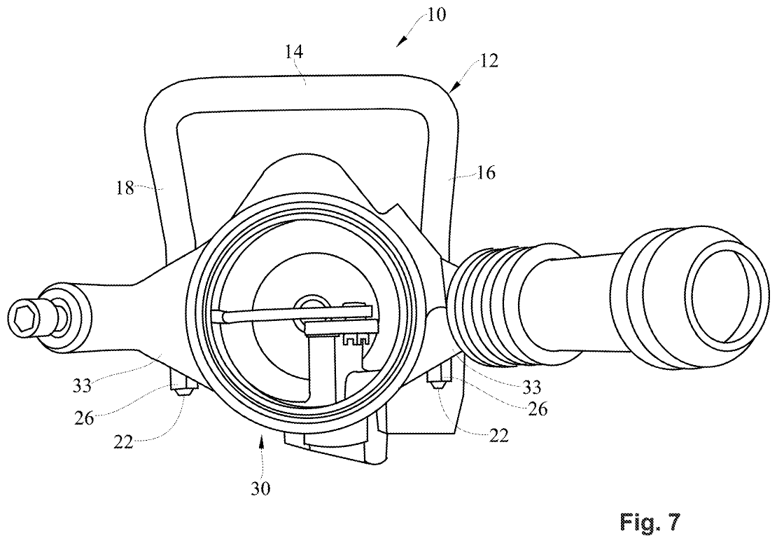

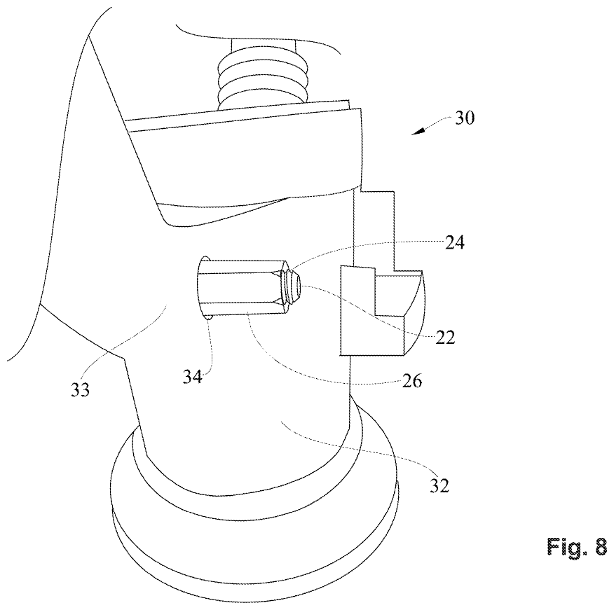

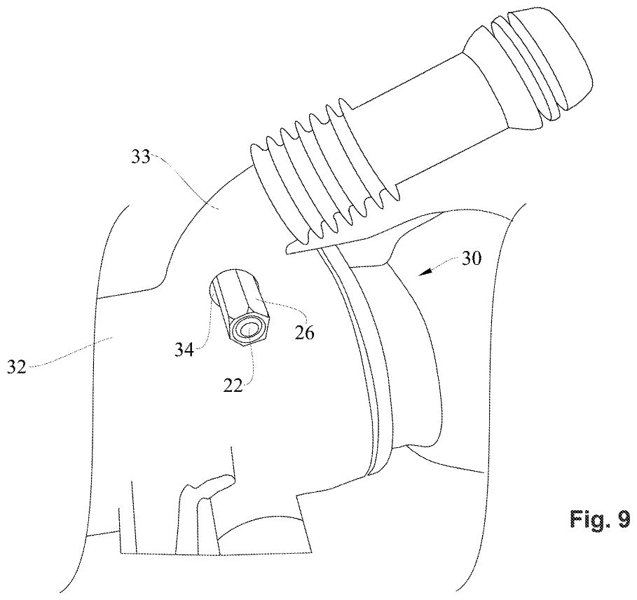

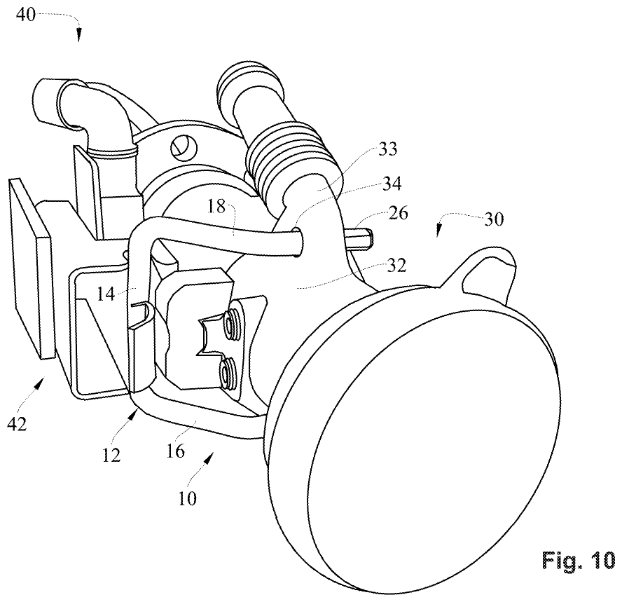

FIG. 6 is a perspective view of the opposite side of the aircraft fuel nozzle 30 in FIG. 5, and shows the U-shaped body 12 of the stow bar 10 attached to the aircraft fuel nozzle 30. FIG. 6 shows the free end 20 of each of the first arm 16 and the second arm 18 extending through one of the first aperture 34 and the second aperture 34 of the flanges 33 of the housing 32. FIG. 6 also shows that because the free end 20 of each of the first arm 16 and the second arm 18 extends at an angle relative to the base part 14 of the U-shaped body 12, the stow bar 10 extends at an angle relative to the aircraft fuel nozzle 30 when the stow bar 10 is secured to the aircraft fuel nozzle 30. The angular extension of the stow bar 10 relative to the aircraft fuel nozzle 30 may help the stow bar 10 interact with a limit switch 42 of a refueling vehicle 40 when the aircraft fuel nozzle 30 is stowed on the refueling vehicle 40, as discussed below with respect to FIGS. 10 and 11. FIG. 7 is a top view of the stow bar 10 attached to the aircraft fuel nozzle 30 of FIGS. 5 and 6, according to an embodiment. FIG. 7 shows the U-shaped body 12 of the stow bar 10 one side of the aircraft fuel nozzle 30, and the male connectors 22 and the nuts 26 on the other side of the aircraft fuel nozzle 30 for securing the stow bar 10 to the aircraft fuel nozzle 30. FIGS. 8 and 9 are a close-up views of a nut 26 attached to a male connector 22 on one side of the aircraft fuel nozzle 30 for securing the stow bar 10 to the aircraft fuel nozzle 30.

With respect to FIGS. 4 to 9, a method of attaching the stow bar 10 to the aircraft fuel nozzle 30 may include inserting the free end 20 of the first arm 16 and the free end 20 of the second arm 18 of the stow bar 10 through the first aperture 34 and the second aperture 34, respectively, of the housing 32 (or flange 33) of the aircraft fuel nozzle 30. A first nut 26 may then be attached to the male connector 22 of the first arm 16 on the other side of the first aperture 34, and a second nut 26 may be attached to the male connector 22 of the second arm 18 on the other side of the second aperture 34. In some embodiments, an adhesive type material or securing agent may be provided between the threads 24 of the male connector 22 and the threads of the nut 26. Once secured to the aircraft fuel nozzle 30, the stow bar 10 may extend at an angle relative to the aircraft fuel nozzle 30. The angle may help the stow bar 10 interact with a limit switch 42 of a refueling vehicle 40 when the aircraft fuel nozzle 30 is stowed on the vehicle 40, as shown in FIGS. 10 and 11.

In particular, FIG. 10 illustrates a portion of a refueling vehicle 40 that includes a limit switch 42 and an aircraft fuel nozzle 30. The limit switch 42 is configured to control a power supply to the refueling vehicle 40 such that power to the refueling vehicle 40 is shut off when the limit switch 42 is not engaged. Disengagement of the limit switch 42 is a safety measure to protect against travel of the refueling vehicle 40 and the potential spilling of jet fuel from the aircraft fuel nozzle 30 until the aircraft fuel nozzle 30 is properly and securely stowed on the refueling vehicle 40 (such as after a refueling operation). FIG. 10 shows that the aircraft fuel nozzle 30 having the stow bar 10 secured thereto is stowed on the refueling vehicle 40. In this position, the base part 14 of the stow bar 10 interacts or engages with the limit switch 42. The angle of the stow bar 10 relative to the aircraft fuel nozzle 30 may assist with the engagement. With the stow bar 10 engaging the limit switch 42, power to the refueling vehicle 40 can be restored.

FIG. 11 is a close-up view of the base part 14 of the stow bar 10 interacting with and engaging the limit switch 42 of the refueling vehicle 40.

Although several preferred embodiments have been illustrated in the accompanying drawings and describe in the foregoing specification, it will be understood by those of skill in the art that additional embodiments, modifications and alterations may be constructed from the principles disclosed herein.

What is claimed is:

1. A stow bar for an aircraft fuel nozzle, comprising:
a U-shaped body formed of a base part, a first arm extending from one side of the base part, and a second arm extending from an opposite side of the base part, wherein
each of the first arm and the second arm comprises a free end located distally of the base part, and
the free end comprises a male connector for insertion through an aperture in a housing or a flange of the aircraft fuel nozzle.

2. The stow bar according to claim 1, wherein the male connector comprises threads.

3. The stow bar according to claim 1, wherein the stow bar is a single, solitary piece.

4. The stow bar according to claim 3, wherein a material of the stow bar is steel.

5. The stow bar according to claim 2, further comprising a threaded nut for engaging with the male connector.

6. The stow bar according to claim 1, wherein the free end of each of the first arm and the second arm extends at an angle relative to the base part.

7. The stow bar according to claim 1, wherein a diameter of the male connector is less than a diameter of the first arm and the second arm.

8. An aircraft fuel nozzle, comprising:
a nozzle part for dispensing fuel;
a housing comprising a first aperture and a second aperture; and
a stow bar comprising a U-shaped body formed of a base part, a first arm extending from one side of the base part, and a second arm extending from an opposite side of the base part, wherein each of the first arm and the second arm comprises a free end located distally of the base part and extending through one of the first aperture and the second aperture, and the free end comprises a male connector.

9. The aircraft fuel nozzle according to claim 8, wherein the male connector comprises threads, and the stow bar further comprises a nut attached to the male connector for securing the stow bar to the housing.

10. The aircraft fuel nozzle according to claim 8, wherein the stow bar is a single, solitary piece.

12. The aircraft fuel nozzle according to claim 8, wherein the free end of each of the first arm and the second arm extends at an angle relative to the base part.

13. The aircraft fuel nozzle according to claim 8, wherein the stow bar is configured to interact with a limit switch of a refueling vehicle when the aircraft fuel nozzle is stowed on the refueling vehicle.

14. A refueling vehicle comprising:
the aircraft fuel nozzle according to claim 8; and
a limit switch for controlling a power supply to the refueling vehicle,
wherein the stow bar is configured to interact with the limit switch when the aircraft fuel nozzle is stowed on the refueling vehicle.

15. A method of attaching a U-shaped stow bar to an aircraft fuel nozzle, comprising:
inserting a free end of a first arm and a free end of a second arm of the U-shaped stow bar through a first aperture and a second aperture, respectively, of a housing of the aircraft fuel nozzle, wherein the free end comprises a male connector;
attaching a first nut to the male connector of the first arm; and
attaching a second nut to the male connector of the second arm.

16. The method according to claim 15, wherein the free end of each of the first arm and the second arm extends at an angle relative to a base part of the U-shaped stow bar so that the base part is disposed at an angle relative to the aircraft fuel nozzle when the free end of the first arm and the free end of the second arm are inserted through the first aperture and the second aperture, respectively, of the housing.

17. The method according to claim 15, wherein the stow bar is a single, solitary piece.

18. The method according to claim 15, wherein the male connector comprises threads.
